(19) United States
(12) Patent Application Publication
(10) Pub. No.: US 2005/0077103 A1
(43) Pub. Date: Apr. 14, 2005

(54) Projection type video display

(75) Inventors: Takashi Ikeda, Osaka (JP); Koji Ishii, Osaka (JP)

Correspondence Address: MCDERMOTT WILL & EMERY LLP, 600 13th Street, N.W., Washington, DC, 20005-3096, US

(73) Assignee: SANYO ELECTRIC CO., LTD.

(21) Appl. No.: 10/944,825

(22) Filed: Sep. 21, 2004

(30) Foreign Application Priority Data
Sep. 26, 2003 (JP) 2003-335241

(51) Int. Cl. H04N 5/66

(52) U.S. Cl. 181/225; 181/224

(57) ABSTRACT

An ion wind generator is provided behind a light source. The ion wind generator 20 negatively-ionizes air by corona discharges using needle-shaped electrodes on the negative side, and draws the negatively-ionized air by a mesh electrode on the ground side to generate an air current. An exhaust port is provided with an ozone decomposition catalyst filter. A path axis for vent holes in the ozone decomposition catalyst filter is inclined to the direction of advancement (a direction toward the exhaust port) of unnecessary light from a lamp from the light source, and the unnecessary light from a lamp is shaded by the ozone decomposition catalyst filter.

### BACKGROUND OF THE INVENTION

1. Field of the Invention

The present invention relates to a projection type video display such as a liquid crystal projector.

2. Disclosure of the Background Art

A projection type video display is so configured that light emitted from a light source is modulated by a light valve such as a liquid crystal panel to be projected, so that it must comprise a high-luminance light source. Consequently, measures to prevent heat generated from the high-luminance light source itself and heat generated when light is absorbed in a light polarizing plate in the liquid crystal panel or various types of optical components are required. Conventionally, a projection type video display has a structure in which air is sucked and exhausted and heat is released from the video display by rotating a fan with a motor (see JP-A-2001-222065).

### SUMMARY OF THE INVENTION

In a suction and exhaust mechanism using motor driving, however, noise is produced due to suction and exhaust sound by rotating sound of a motor and hissing sound of a fan, and the noise produced by the suction and exhaust sound is offensive to the ear when a projector is employed.

Therefore, the applicant of the present invention has previously filed a projection type video display equipped with an ion wind generator (Japanese Patent Application No. 2002-361140). The ion wind generator is so configured as to ionize air negatively by corona discharges using a lot of needle-shaped electrodes 21 on the negative side and draw the negatively-ionized air by a mesh electrode 22 on the ground side to generate an air current, as shown in FIG. 4. The ion wind generator 20 is provided behind a light source (a lamp) 1. When the air current generated by the ion wind generator 20 is exhausted outward from the video display, ambient air heated to high temperature by heat from the light source 1 is drawn and is exhausted outward from the video display on the air current. An exhaust port on a back of a casing of the video display is provided with an ozone decomposition catalyst filter 23. Ozone (O₃) is generated by corona discharges in the ion wind generator 20. The ozone is introduced outward from the video display on the air current. The ozone is decomposed by being passed through the ozone decomposition catalyst filter 23 provided at the exhaust port.

However, there is a disadvantage that light leaking out of a back of the light source 1 (unnecessary light) enters the eyes of a user after passing through the ozone decomposition catalyst filter 23 and the exhaust port. Particularly, the projection type video display is employed in a room with a light darkened, so that unnecessary light is noticeable, thereby reducing the contrast of a projected video on a screen. On the other hand, in order to intercept the unnecessary light, it is considered that a shading plate 25 is arranged, as shown in FIG. 5. When the shading plate 25 is provided, however, the video display is increased in size. Further, the air current is also shut off, resulting in degradation in cooling capability. Even if the shading plate 25 is provided on the downstream side of the ozone decomposition catalyst filter 23, the same disadvantages occur.

In view of the foregoing circumstances, an object of the present invention is to provide a projection type video display using an ion wind generator as a cooling device and capable of preventing unnecessary light from leaking out of the video display while restraining the degradation in cooling capability.

In order to solve the above-mentioned problem, in a projection type video display that modulates light emitted from a light source by a light valve and projects the modulated light, a projection type video display according to the present invention is characterized by comprising a wind blower for ionizing air and molecules in the air by an electrode on one side and drawing ions generated by the ionization by an electrode on the other side, to generate an air current; and an ozone removal filter having a plurality of vents for removing ozone in the air current passing through the vents, and also characterized in that the wind blower and the ozone removal filter are arranged behind the light source, and the ozone removal filter is arranged such that its vents are inclined to the direction of light leaking out of a back of the light source and then advancing toward an exhaust port or a suction port.

In the above-mentioned configuration, the wind blower electrically moves the ionized air or the like to generate an air current. Accordingly, unlike blowing by the rotation of a fan, no rotation noise is produced, so that a sound of air suction and exhaust can be reduced up to almost soundless state. Even if the ozone is generated by the ionization, the ozone is removed by the ozone removal filter. The ozone removal filter is so arranged that its vents are inclined to the direction of light leaking out of the back of the light source and advancing toward the exhaust port or the suction port. Therefore, it is possible to prevent unnecessary light from leaking out of the exhaust port or the suction port.

The ozone removal filter may have its air suction surface and air exhaust surface arranged therein perpendicularly to the direction of light advancing toward the exhaust port or the suction port, and may be so formed that the vents of the ozone removal filter are inclined to the surfaces.

Alternatively, the ozone removal filter may have its suction surface and air exhaust surface arranged therein not perpendicularly to the direction of light advancing toward the exhaust port and the suction port, and may be so formed that the vents are perpendicular to the surfaces.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a projection type video display according to an embodiment of the present invention;

FIG. 2 is an explanatory view showing an ion wind generator and an ozone decomposition removal filter;

FIG. 3 is an explanatory view showing an ion wind generator and an ozone decomposition removal filter having another configuration;

FIG. 4 is an explanatory view showing an ion wind generator having a structure previously filed by the applicant of the present invention; and

FIG. 5 is an explanatory view showing an ion wind generator provided with a shading plate.

### DESCRIPTION OF THE PREFERRED EMBODIMENTS

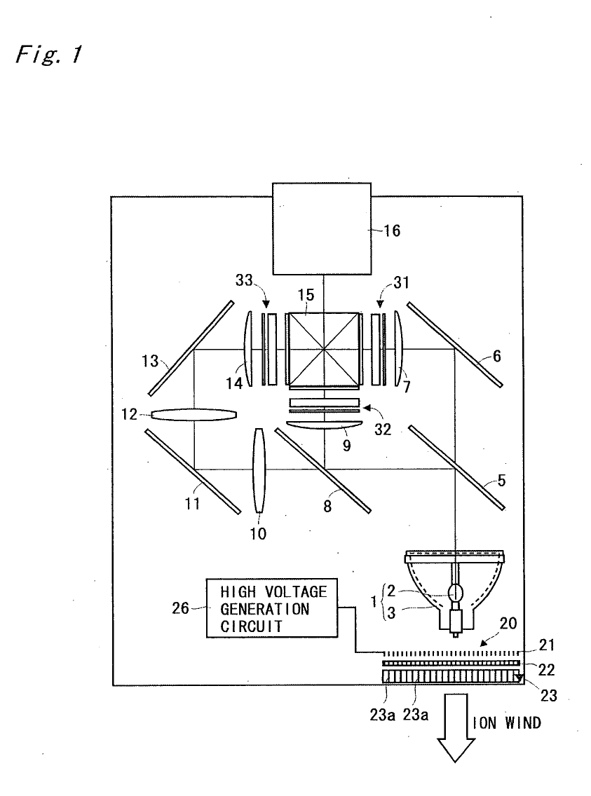

A projection type video display according to an embodiment of the present invention will be described on the basis of FIGS. 1 to 3.

FIG. 1 is a diagram showing an optical system for a three-panel type color liquid crystal projector. A light emitter 2 in a light source 1 is composed of a ultra-high pressure mercury lamp, a metal halide lamp, a xenon lamp, or the like, and its irradiated light is emitted after being changed into parallel light by a parabolic reflector 3, for example.

A first dichroic mirror 5 transmits light in a red wavelength band, and reflects light in a cyan (green+blue) wavelength band. The light in the red wavelength band which has passed through the first dichroic mirror 5 is reflected from a mirror 6 so that its optical path is changed. The red light which is reflected from the mirror 6 is optically modulated by passing through a transmission type liquid crystal light valve for red light 31 through a condenser lens 7. On the other hand, the light in the cyan wavelength band which is reflected from the first dichroic mirror 5 is introduced into a second dichroic mirror 8.

The second dichroic mirror 8 transmits light in a blue wavelength band, and reflects light in a green wavelength band. The light in the green wavelength band which is reflected from the second dichroic mirror 8 is introduced into a transmission type liquid crystal light valve for green light 32 through a condenser lens 9, and is optically modulated by passing through the transmission type liquid crystal light valve for green light 32. The light in the blue wavelength band which has passed through the second dichroic mirror 8 is introduced into a transmission type liquid crystal light valve for blue light 33 through mirrors 11 and 13, relay lenses 10 and 12, and a condenser lens 14, and is optically modulated by passing through the transmission type liquid crystal light valve for blue light 33.

Each of the liquid crystal light valves 31, 32, and 33 comprises an incidence-side polarizing plate, a panel constructed by sealing a liquid crystal between a pair of glass boards (having a pixel electrode or an alignment film formed therein), and an emission-side polarizing plate. Modulated lights (video lights in respective colors) which have been respectively modulated by passing through the liquid crystal light valves 31, 32, and 33 are mixed by a cross dichroic prism 15, to be a color video light. The color video light is enlarged and projected by a projection lens 16, and is displayed on a screen (not shown).

An ion wind generator 20 is provided at a position behind the light source 1. The ion wind generator 20 is so configured as to ionize air negatively by corona discharges using a lot of needle-shaped electrodes 21 on the negative side and draw the negatively-ionized air by a mesh electrode 22 on the ground side to generate an air current. A high-voltage generation circuit 26 is supplied with a voltage from a power supply (not shown), to generate a high voltage of minus several kilovolts to minus ten and several kilovolts and apply the high voltage to the electrodes 21.

As shown in FIG. 1, a blower port of the ion wind generator 20 is directed to an exhaust port on a back of a casing of the projector. When the air current generated by the ion wind generator 20 is exhausted outward from the projector, ambient air heated to high temperature by heat from the light source 1 is drawn and is exhausted outward from the projector on the air current.

The exhaust port on the back of the casing of the projector is provided with an ozone decomposition catalyst filter 23. The ozone decomposition catalyst filter 23 is constructed by additionally attaching a catalyst such as manganese dioxide, nickel oxide, or activated carbon to wall surfaces of vent holes 23a having a honeycomb structure, for example. Ozone (O₃) is generated by corona discharges in the ion wind generator 20, and the ozone is introduced outward from the projector on the air current. The ozone is decomposed by being passed through the vent holes 23a in the ozone decomposition catalyst filter 23 provided at the exhaust port.

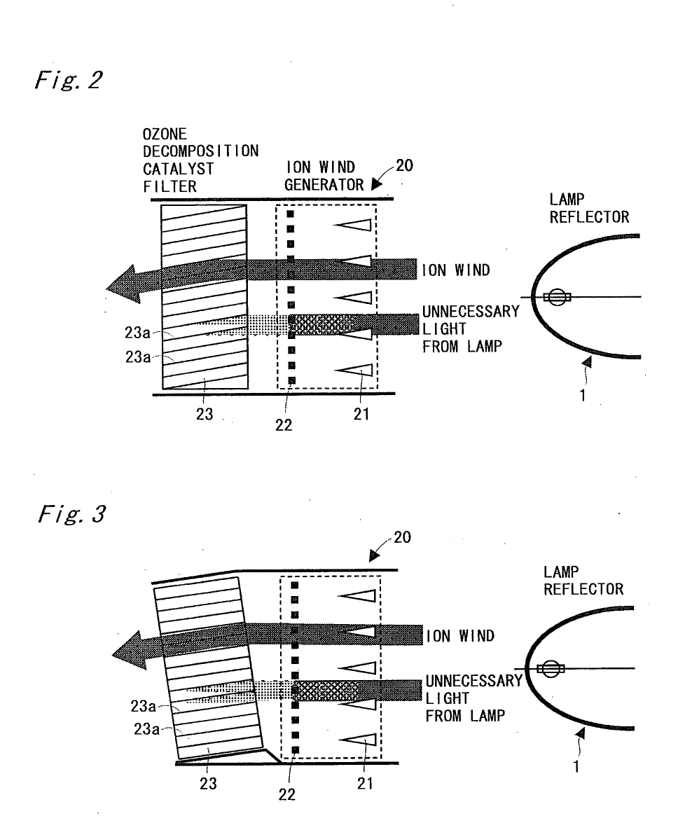

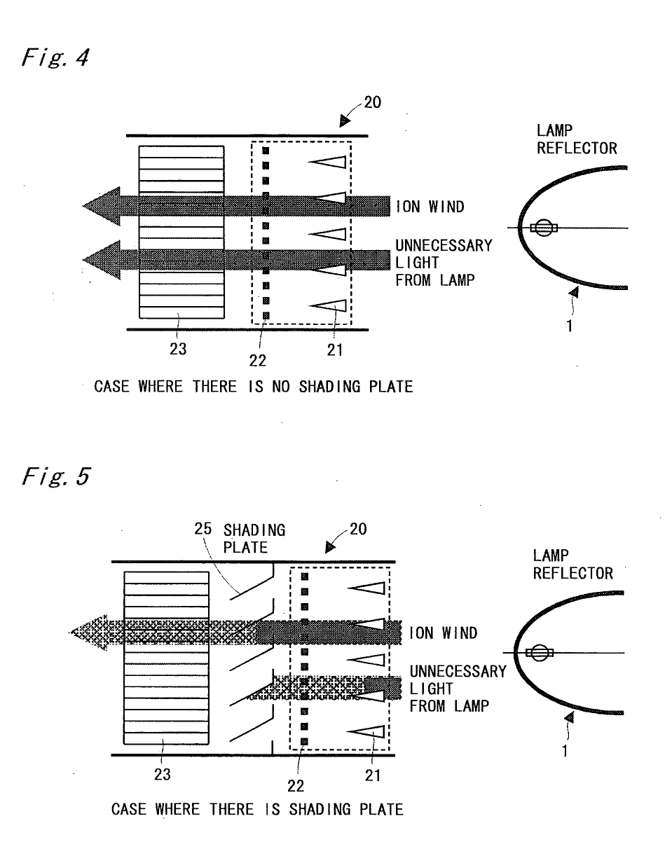

The ozone decomposition catalyst filter 23 shown in FIG. 2 has its air suction surface and air exhaust surface arranged therein perpendicularly to the direction of advance of unnecessary light from a lamp (a direction toward the exhaust port) and is so formed that the vent holes 23a are inclined to the air suction surface and the air exhaust surface.

The ozone decomposition catalyst filter 23 shown in FIG. 3 has its air suction surface and air exhaust surface arranged therein not perpendicular to the direction of advancement of unnecessary light from a lamp (a direction toward the exhaust port) and is so formed that the vent holes 23a are perpendicular to the air suction surface and the air exhaust surface.

In either of the configurations shown in FIGS. 2 and 3, the vent holes 23a are inclined at an angle to the direction of advancement of the unnecessary light from a lamp (a direction toward the exhaust port), and the unnecessary light from a lamp is shaded by the ozone decomposition catalyst filter 23. The diameter (the width) of the vent hole 23a in the ozone decomposition catalyst filter 23 is extremely small. Therefore, the shading is possible only by slightly inclining the vent holes 23a, and ion wind is hardly prevented from flowing, thereby restraining the degradation in cooling capability. From the viewpoint of shading (further, the rise in temperature, described later), it is desirable that inner walls of the vent holes 23a are black.

A certain temperature is required to allow the ozone decomposition catalyst filter 23 to decompose ozone sufficiently. If a path direction for the vent holes 23a is inclined to the direction of advancement of the unnecessary light from a lamp, as described above, the catalyst on the vent holes 23a easily rises in temperature by receiving the unnecessary light from a lamp, so that the ozone decomposition capability is enhanced. Particularly, infrared rays are useful for the rise in temperature. If a so-called cold lamp whose reflector is constructed with a cold mirror which transmits infrared ray is used, the infrared rays are easy to take out.

Although in the above-mentioned example, high-temperature air around the light source 1 is drawn and is introduced outward from the projector by the ion wind generated by the ion wind generator 20, the ion wind generated by the ion wind generator 20 may be blown on the light source 1. In this case, the ozone decomposition catalyst filter 23 may be arranged in the vicinity of the reflector 3 in the light source 1. The positive-and-negative relationship of an electrode on one side and an electrode on the other side in the ion wind generator 20 may be reversed. Further, if an air current is generated by ionizing the air or molecules in the air, an ion wind generator having a configuration different from the configuration specifically described above can be used.

Although in the above-mentioned example, the video generating optical system using three transmission-type liquid crystal display panels is illustrated, the present invention is not limited to the video generating optical system. For example, the present invention is also applicable to a case where another video generating optical system is used.

As described in the foregoing, according to the present invention, unnecessary light can be prevented from leaking out of the projector while using the ion wind generator as a cooling device and restraining the reduction in the cooling capability.

Although the present invention has been described and illustrated in detail, it is clearly understood that the same is by way of illustration and example only and is not to be taken by way of limitation, the spirit and scope of the present invention being limited only by the terms of the appended claims.

1. In a projection type video display that modulates light emitted from a light source by a light valve and projects the modulated light,
a projection type video display comprising
a wind blower for ionizing air and molecules in the air by an electrode on one side and drawing ions generated by the ionization by an electrode on the other side, to generate an air current; and
an ozone removal filter having a plurality of vents for removing ozone in the air current passing through the vents, and wherein
the wind blower and the ozone removal filter are arranged behind the light source, and
the ozone removal filter is arranged such that the vents are inclined to the direction of light leaking out of a back of the light source and advancing toward an exhaust port or a suction port.

2. The projection type video display according to claim 1, wherein
the ozone removal filter has its air suction surface and air exhaust surface arranged therein perpendicularly to the direction of the light from the light source, and is so formed that the vents are inclined to the surfaces.

3. The projection type video display according to claim 1, wherein
the ozone removal filter has its air suction surface and air exhaust surface arranged therein not perpendicularly to the direction of the light from the light source, and is so formed that the vents are perpendicular to the surfaces.

4. The projection type video display according to claim 1, wherein
the inner walls of the vents of the ozone removal filter are black.

5. The projection type video display according to claim 2, wherein
the inner walls of the vents of the ozone removal filter are black.

6. The projection type video display according to claim 3, wherein
the inner walls of the vents of the ozone removal filter are black.

7. The projection type video display according to claim 1, wherein
the light source comprises a cold lamp whose reflector is constructed with a cold mirror which transmits infrared ray and,
the infrared ray emitted from the cold lamp is introduced into the ozone removal filter.

8. The projection type video display according to claim 2, wherein
the light source comprises a cold lamp whose reflector is constructed with a cold mirror which transmits infrared ray and,
the infrared ray emitted from the cold lamp is introduced into the ozone removal filter.

9. The projection type video display according to claim 3, wherein
the light source comprises a cold lamp whose reflector is constructed with a cold mirror which transmits infrared ray and,
the infrared ray emitted from the cold lamp is introduced into the ozone removal filter.

10. The projection type video display according to claim 4, wherein
the light source comprises a cold lamp whose reflector is constructed with a cold mirror which transmits infrared ray and,
the infrared ray emitted from the cold lamp is introduced into the ozone removal filter.

11. The projection type video display according to claim 5, wherein
the light source comprises a cold lamp whose reflector is constructed with a cold mirror which transmits infrared ray and,
the infrared ray emitted from the cold lamp is introduced into the ozone removal filter.

12. The projection type video display according to claim 6, wherein
the light source comprises a cold lamp whose reflector is constructed with a cold mirror which transmits infrared ray and,
the infrared ray emitted from the cold lamp is introduced into the ozone removal filter.
